(19) United States
(12) Patent Application Publication
(10) Pub. No.: US 2017/0142704 A1
(43) Pub. Date: May 18, 2017

(54) APPARATUS AND METHOD FOR SUPPORTING VARIOUS TRANSMISSION TIME INTERVALS

(71) Applicant: ELECTRONICS AND TELECOMMUNICATIONS RESEARCH INSTITUTE, Daejeon (KR)

(72) Inventors: Soojung JUNG, Daejeon (KR); Won-Ik KIM, Daejeon (KR); Sung Cheol CHANG, Daejeon (KR); Seungkwon CHO, Daejeon (KR)

(73) Assignee: ELECTRONICS AND TELECOMMUNICATIONS RESEARCH INSTITUTE, Daejeon (KR)

(21) Appl. No.: 15/349,599

(22) Filed: Nov. 11, 2016

(30) Foreign Application Priority Data
Nov. 12, 2015 (KR) 10-2015-0159230
Nov. 8, 2016 (KR) 10-2016-0148304

(51) Int. Cl. H04W 72/04; H04W 72/08; H04L 5/00

(52) U.S. Cl. CPC H04W 72/0413; H04L 5/001; H04W 72/048; H04W 72/085

(57) ABSTRACT

A terminal transmits and receives data by using legacy transport channels and legacy physical channels, which operate based on a first TTI, configures, when a service requiring an operation of a new second TTI is generated, new transport channels and new physical channels which operate based on the second TTI while configuring a new radio bearer, and thereafter, transmits and receives data of the service by using the new transport channels and the new physical channels.

### CROSS-REFERENCE TO RELATED APPLICATION

This application claims priority to and the benefit of Korean Patent Application Nos. 10-2015-0159230, and 10-2016-0148304 filed in the Korean Intellectual Property Office on Nov. 12, 2015, Nov. 8, 2016, and the entire contents of which are incorporated herein by reference.

### BACKGROUND OF THE INVENTION

(a) Field of the Invention

The present invention relates to an apparatus and a method for supporting various transmission time intervals, and more particularly, to structures and functions of MAC layer of a base station and a terminal for simultaneously supporting various transmission time intervals (TTIs) having different values in a mobile communication system.

(b) Description of the Related Art

In legacy long term evolution (LTE)/LTE-advanced (A) system, a medium access control (MAC) layer of a base station and a terminal is associated with the radio link control (RLC) which is the higher layer and the physical layer (PHY) which is a lower layer and handles multiplexing of logical channels provided by the higher layer, hybrid automatic repeat request (HARQ) retransmission, downlink and uplink resource allocation (a scheduling function), a random access procedure control, and the like. The scheduling function is located in the MAC layer of the base station. Further, the MAC layer is responsible for logical channel prioritization (LCP) function for the uplink. MAC entities in both the base station and the terminal are controlled through transmitting/receiving MAC control messages (MAC CEs). The MAC layer provides the transport channels to the PHY layer which is the lower layer.

When multiple component carriers are supported in case of carrier aggregation (CA) operation, one MAC entity in each of the base station and the terminal is responsible for handling a multiple component carriers. However, an HARQ entity per component carrier individually operates. As a result, data of the multiple logical channels are multiplexed to form one transport block (TB) per component carrier and the MAC layer provides a TB (MAC PDU) per component carrier to the PHY layer over the transport channel after scheduling is performed in each TTI. The PHY layer of each component carrier, which receives the transport block independently performs HARQ retransmission and control signaling transmission/reception.

In case of dual connectivity (DC) operation, the MAC entity is defined for each base station which communicates in the terminal. Functions and structures of the separate MAC entities are the same as that of CA operation. However, since a radio resource control (RRC) layer of a control plane is resides only in a master eNB (MeNB), the logical channels associated with the control plane functionality such as the paging control channel (PCCH), the common control channel (CCCH), the dedicated control channel (DCCH), and the like are not defined in a secondary eNB (SeNB).

In the LTE/LTE-A network, a radio bearer (RB) is configured between the base station and the terminal as a part of an evolved packet system (EPS) bearer which is a pipe line through which user service traffic (IP flow) is transferred. One packet data convergence protocol (PDCP) entity, and one RLC entity, and logical channels per RB are configured, and related transport channels and related physical channels are configured.

Such as real time control or tactile Internet applications, low-latency services having new quality of service (QoS) requirements, i.e., short transmission delay of a radio section, are anticipated as new services to be provided through mobile communication afterwards. In case that a newly required QoS is a short radio section transmission delay, changing the TTI of the radio section is required so as to satisfy the corresponding requirements. Without changing the higher-layer protocol and orthogonal frequency division multiplexing (OFDM) parameter values of the legacy LTE/LTE-A, a method that sets the TTI value to a value smaller than the legacy value changes a size and a transport format of the TB transmitted to the radio section.

Accordingly, a method for supporting various TTIs having different values without changing the RB configuration procedure, the protocol of the higher layer, and the OFDM parameter values in the current LTE/LTE-A is required.

### SUMMARY OF THE INVENTION

The present invention has been made in an effort to provide an apparatus and a method which can support various TTIs having different values.

An exemplary embodiment of the present invention provides a method for supporting various transmission time intervals (TTIs) having different values by a terminal. The method includes: transmitting data by using legacy transport channels and legacy physical channels, which operate based on a first TTI; configuring, when a service requiring an operation of a new second TTI is generated, new transport channels and new physical channels which operate based on the second TTI while configuring new radio bearers; and transmitting data of the service by using the new transport channels and the new physical channels.

A first radio resource in which the new physical channels are transmitted may be different from a second radio resource in which the legacy physical channels are transmitted.

The first radio resource may be a radio resource in a first region in a radio frame of a component carrier and the second radio resource may be the radio resource in a second region different from the first region in the radio frame of the single component carrier.

The configuring of the new transport channels and the new physical channels may include configuring the new transport channels and the new physical channels by using the radio frame of a first component carrier among multiple component carriers when the terminal supports carrier aggregation, and the legacy transport channels and the legacy physical channels may be configured by using the radio frame of a second component carrier different from the first component carrier among the multiple component carriers.

The configuring of the new transport channels and the new physical channels may include configuring the new transport channels and the new physical channels in one group of a master cell group and a secondary cell group when the terminal supports the carrier aggregation and dual connectivity, and the legacy transport channels and the legacy physical channels may be configured in the other cell group of the master cell group and the second cell group.

The configuring of the new transport channels and the new physical channels may include configuring, when the operation of the second TTI is supported only in the user plane, new transport channels and new physical channels associated with the functionality of the user plane, and configuring, when the operation of the second TTI is supported in both the control plane and the user plane, new transport channels and new physical channels associated with the functionality of the control plane and the user plane.

The method may further include performing a transmitting/receiving operation by using the legacy transport channels and the legacy physical channels when the service ends.

The method may further include performing the transmitting/receiving operation by using the legacy transport channels and the legacy physical channels when a state of the terminal becomes the radio resource control idle (RRC IDLE) state.

Another exemplary embodiment of the present invention provides an apparatus for supporting various transmission time intervals (TTIs) having different values by a terminal. The apparatus includes: a processor; and a transceiver. The processor may configure, when a new service requiring an operation of a new second TTI is generated while a service is provided by using legacy transport channels and legacy physical channels which operate at a first TTI, new transport channels and new physical channels which operate at the second TTI. In addition, the transceiver transmits and receives data of the new service by using a radio resource of the new physical channels.

The first TTI may have a time length of 1 ms and the second TTI may have a shorter time length than the first TTI.

The processor may configure new transport channels and new physical channels which operate based on the second TTI in the medium access control (MAC) layer and the physical layer while configuring a new radio bearer for the new service.

The processor may configure the new physical channels by using the radio resource different from the radio resource of the legacy physical channels.

The processor may configure the new physical channels by using the radio frame of a first component carrier among multiple component carriers and configure the legacy physical channels by using the radio frame of a second component carrier different from the first component carrier, when the terminal supports carrier aggregation.

The processor may configure the new physical channels by using the radio resource in a partial region of the radio frame of a component carrier and configure the legacy physical channels by using the radio resource in the remaining partial region of the radio frame of the single component carrier.

The processor may configure the new transport channels and the new physical channels in one group of a master cell group and a secondary cell group when the terminal supports the carrier aggregation and dual connectivity and configure the legacy transport channels and the legacy physical channels in the other cell group.

Yet another exemplary embodiment of the present invention provides an apparatus for supporting various transmission time intervals (TTIs) having different values by a base station. The apparatus includes: a processor; and a transceiver. The processor distinguishes transport channels and physical channels for each of TTIs having different time lengths from each other and configures the transport channels and physical channels. In addition, the transceiver transmits and receives data of a service by using transport channels and physical channels which operate based on a TTI required by the service.

The processor may separately configure the physical layers according to TTI values.

The processor may distinguish a radio resource region for each TTI in a radio frame of a component carrier and configure the physical channels for each TTI by using the radio resource region distinguished for each TTI.

The processor may configure different TTIs for each component carrier when multiple component carriers are supported.

The processor may configure transport channels and physical channels associated with a functionality of the user plane for each TTI when the terminal which communicates with the secondary base station of dual connectivity. The processor may configure transport channels and physical channels associated with the functionality of both the control plane and the user plane for each TTI when the base station is a master base station of dual connectivity.

### BRIEF DESCRIPTION OF THE DRAWINGS

FIG. 1 is a diagram illustrating a radio protocol structure of a terminal and a base station in the legacy LTE/LTE-A system.

FIG. 2 is a diagram illustrating a channel mapping relationship of logical channels, transport channels, and physical channels in the legacy LTE/LTE-A system.

FIG. 3 is a diagram illustrating one example of transport blocks configuration by various TTIs according to an exemplary embodiment of the present invention.

FIGS. 4 and 5 are diagrams examples of the MAC layer and the PHY layer for supporting various TTIs according to an exemplary embodiment of the present invention, respectively.

FIG. 6 is a diagram illustrating one example of a channel mapping relationship of a base station for supporting various TTIs according to an exemplary embodiment of the present invention.

FIG. 7 is a diagram illustrating one example of a channel mapping relationship of a terminal for supporting various TTIs according to an exemplary embodiment of the present invention.

FIG. 8 is a diagram illustrating another example of a channel mapping relationship of a base station for supporting various TTIs according to an exemplary embodiment of the present invention.

FIG. 9 is a diagram illustrating another example of a channel mapping relationship of a terminal for supporting various TTIs according to an exemplary embodiment of the present invention.

FIG. 10 is a diagram illustrating one example of a radio resource configuration for supporting various TTIs in a component carrier according to an exemplary embodiment of the present invention.

FIG. 11 is a diagram illustrating a detailed structure of the MAC layer and a reconfiguration procedure of the MAC layer of a terminal according to an exemplary embodiment of the present invention.

FIG. 12 is a diagram for describing reconfiguration of the MAC layer of a terminal according to an exemplary embodiment of the present invention.

FIG. 13 is a diagram illustrating another example of a detailed structure of the MAC layer of a terminal according to an exemplary embodiment of the present invention.

FIG. 14 is a diagram illustrating one example of a radio resource configuration for supporting various TTIs when multiple component carriers are supported according to an exemplary embodiment of the present invention.

FIG. 15 is a diagram illustrating one example of a detailed structure of the MAC layer of a terminal when multiple component carriers are supported according to an exemplary embodiment of the present invention.

FIG. 16 is a diagram illustrating one example of a radio resource configuration for supporting various TTIs when dual connectivity is supported according to an exemplary embodiment of the present invention.

FIG. 17 is a diagram illustrating one example of a detailed structure of the MAC layer of a terminal when dual connectivity is supported according to an exemplary embodiment of the present invention.

FIG. 18 is a diagram illustrating an apparatus for supporting various TTIs according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements.

Throughout the specification, a terminal may be designated as a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and include all or some of the terminal, the MT, the MS, the AMS, the HR-MS, the SS, the PSS, the AT, the UE, and the like.

Further, a base station (BS) may be designated as an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as the base station, a relay node (RN) serving as the base station, an advanced relay station (ARS) serving as the base station, a high reliability relay station (HR-RS) serving as the base station, small-sized base stations [femoto BS, a home node B (HNB), a home eNodeB (HeNB), a pico BS, A macro BS, a micro BS, and the like], and the like and include all or some functions of the ABS, the NodeB, the eNodeB, the AP, the RAS, the BTS, the MMR-BS, the RS, the RN, the ARS, the HR-RS, the small-sized base stations, and the like.

Hereinafter, an apparatus and a method for supporting various transmission time intervals according to exemplary embodiments of the present invention will be described in detail with reference to drawings.

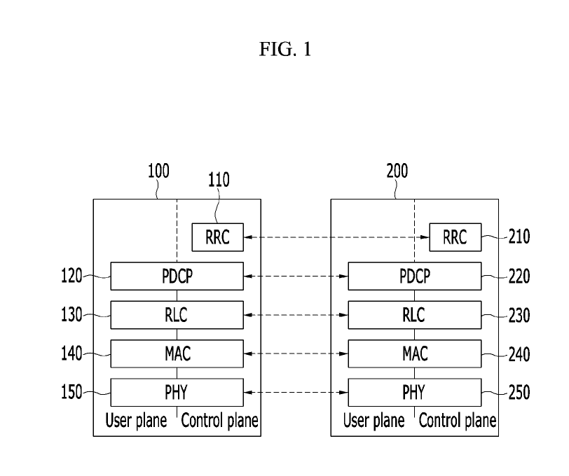

FIG. 1 is a diagram illustrating a radio protocol structure of a terminal and a base station in the legacy LTE/LTE-A system.

Referring to FIG. 1, the radio protocol may be constituted by radio resource control (RRC) layers 110 and 210, packet data convergence protocol (PDCP) layers 120 and 220, radio link control (RLC) layers 130 and 230, medium access control (MAC) layers 140 and 240, and physical (PHY) layers 150 and 250 in the terminal 100 and the base station 200, respectively.

The PHY layers 150 and 250 provide an information transfer service to the higher layer by using physical channels. The PHY layers 150 and 250 are connected with the medium access control (MAC) layer which is the higher layer through transport channels. Data move between the MAC layers 140 and 240 and the PHY layers 150 and 250 through the transport channels. The transport channels are classified according to how and by what feature the data is transmitted through the radio interface.

The data moves between different PHY layers 150 and 250, that is, the PHY layers 150 and 250 of a transmitter and a receiver through the physical layer. The PHY layers 150 and 250 may be modulated by an orthogonal frequency division multiplexing (OFDM) method and use a time and a frequency as radio resources.

Functions of the MAC layers 140 and 240 include mapping between the logical channels and the transport channels, multiplexing RLC PDUs which belong to the different logical channels to the MAC PDU, and demultiplexing the MAC PDU to the RLC PDUs. The MAC layers 140 and 240 provide a service to the RLC layers 130 and 230 through the logical channels.

The functions of the RLC layers 130 and 230 include concatenation, segmentation, and reassembly of an RLC service data unit (SDU). In order to guarantee various quality of services (QoS) required by a radio bearer (RB), the RLC layers 130 and 230 provide three operation modes of a transparent mode (TM), an unacknowledged mode (UM), and an acknowledged mode (AM). An AM RLC provides error correction through an automatic repeat request (ARQ).

The functions of the PDCP layers 120 and 220 in a user plane include transfer, header compression, and ciphering of user data. The functions of the PDCP layers 120 and 220 in a control plane include transfer and ciphering/integrity protection of control plane data.

The RRC layers 110 and 210 are defined only in the control plane. The RRC layers 110 and 210 take charge of controlling the logical channels, the transport channels, and the physical channels in association with configuration, reconfiguration, and release of the RBs.

The RB means a logical path provided by a first layer (the PHY layer) and a second layer (the MAC layer, the RLC layer, and the PDCP layer) for data transfer between the terminal 110 and the network. Configuration of the RB means a process that defines characteristics of a radio protocol layer and a radio protocol channel in order to provide a specific service and sets respective detailed parameters and operation methods. The RBs may be divided into a signaling RB (SRB) and a data RB (DRB). The SRB is used as a passage for transmitting an RRC message in the control plane and the DRB is used as a passage for transmitting the user data in the user plane.

When an RRC connection is present between the RRC layer 110 of the terminal 100 and the RRC layer of an evolved terrestrial radio access network (E-UTRAN), the terminal 100 is in an RRC connected state and if not, the terminal 100 is in an RRC idle state.

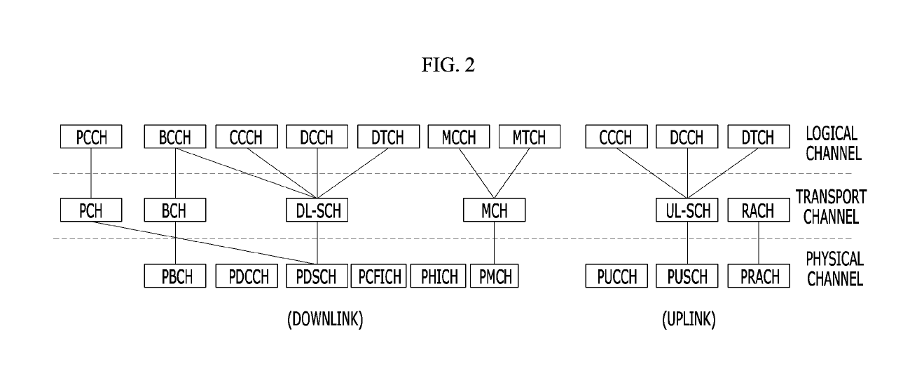

FIG. 2 is a diagram illustrating a channel mapping relationship of logical channels, transport channels, and physical channels in the legacy LTE/LTE-A system.

Referring to FIG. 2, the downlink transport channels for transmitting data from the network to the terminal includes the broadcast channel (BCH) for transmitting system information and the DL-SCH which is the downlink shared channel (SCH) for transmitting a user traffic or control message other than the system information. The traffic or control message of a downlink multicast or broadcast service may be transmitted through the DL-SCH and transmitted through the downlink multicast channel (MCH). Meanwhile, uplink transport channels for transmitting data from the terminal to the network includes the random access channel (RACH) for transmitting an initial control message and the UL-SCH which is an uplink shared channel (SCH) for transmitting other user traffic or control message.

The logical channels which are higher than the transport channels and are mapped to the transport channels include the broadcast control channel (BCCH), the paging control channel (PCCH), the common control channel (CCCH), the multicast control channel (MCCH), the multicast traffic channel (MTCH), and the like.

The downlink physical channels include the physical downlink shared channel (PDSCH), the physical broadcast channel (PBCH), the physical multicast channel (PMCH), the physical control format indicator channel (PCFICH), the physical downlink control channel (PDCCH), and the physical hybrid ARQ indicator channel (PHICH) and the uplink physical channel includes a physical uplink shared channel (PUSCH), the physical uplink control channel (PUCCH), and the physical random access channel (PRACH).

In the downlink and the uplink, the logical channels, the transport channels, and the physical channels have the channel mapping relationship illustrated in FIG. 2.

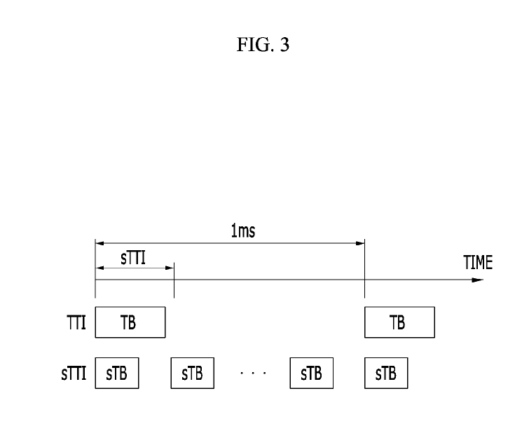

FIG. 3 is a diagram illustrating one example of transport blocks configuration by various TTIs according to an exemplary embodiment of the present invention.

Referring to FIG. 3, the MAC layer determines the size of the transport block (TB) which is a data block transmitted per transmission time interval (TTI) and processes the TB having the determined size.

The TTI is scheduling unit for data transmission performed by the MAC layer, and the TTI of the LTE/LTE-A system is defined as 1 ms which is the length of one subframe.

In order to support a low-latency service having new QoS requirements including a short transmission delay of the radio section, and the like, a TTI (hereinafter, referred to as “short TTI (sTTI)” having a shorter length than 1 ms may be used. When a minimum time unit of the sTTI is configured as one symbol, sTTIs having various lengths may be provided by the unit of the multiple of the symbol. Further, in order to support services of another QoS which permits a delay time having a larger value than the legacy service, a long TTI having a longer length than legacy 1 ms may be used. The long TTI may be provided with various lengths by the unit of the multiple of the legacy TTI.

The data block transmitted during the sTTI is referred to as a short TB (hereinafter, referred to as “sTB”) and the size of the sTB may be determined according to the length of the sTTI. The data block transmitted at the long TTI is referred to as a long TB and the size of the long TB may be determined according to the length of the long TTI.

Hereinafter, exemplary embodiments of the present invention will be described based on the legacy TTI of 1 ms and the sTTI having the shorter length than 1 ms for easy description. When the long TTI supported simultaneously with the legacy TTI is additionally defined, the physical channels of the PHY layer and the transport channels of the MAC layer for the long TTI may be defined in a similar method to the sTTI described below.

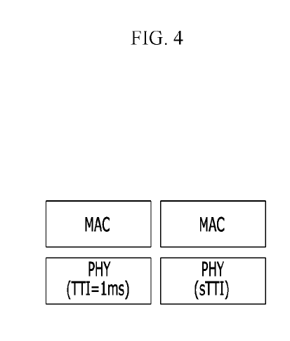

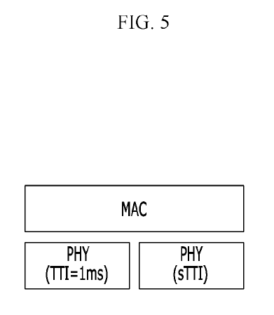

FIGS. 4 and 5 are diagrams illustrating examples of the MAC layer and the PHY layer for supporting various TTIs according to an exemplary embodiment of the present invention, respectively.

Referring to FIGS. 4 and 5, the PHY layers for the legacy TTI and the sTTI are respectively configured. The MAC layer may be configured for each of the legacy TTI and the sTTI and one MAC layer may manage the PHY layers for the legacy TTI and the sTTI.

That is, as illustrated in FIG. 4, the MAC layer and the PHY layer may be distinguished for each of the legacy TTI and the sTTI and as illustrated in FIG. 5, one MAC layer may be configured and only the PHY layers may be configured according to a TTI which operates. In this case, the PHY layers which operate according to the legacy TTI and the sTTI, respectively may use the physical channels which are distinguished from each other.

A method for distinguishing and separate configuring the MAC layer and the PHY layer for each of the legacy TTI and the sTTI may be applied when dual connectivity (DC) is supported and a method for configuring one MAC layer and separately configured PHY layers for the legacy TTI and the sTTI may be applied when carrier aggregation (CA) is supported or when different TTI is provided to each component carrier. When cross-carrier scheduling is not supported, only the resources in each component carrier may be allocated to the physical channels configured to operate according to TTI of each component carrier. When the CA is not supported and only one component carrier is supported, the legacy TTI and the sTTI may be supported in one frame structure and the physical channels of the respective resource regions may be configured to operate at different TTIs which are distinguished from each other.

Further, new transport channels and new physical channels for supporting the operation of the sTTI may be configured at the time of initial access procedure of the terminal supporting the low-latency service of the new QoS, and the like. That is, new configurations of the transport channels and the physical channels may be determined according to whether to support the sTTI operation for the control plane functionality and the user plane functionality of the terminal. In the case of the user plane directly associated with data transmission of the low-latency service requiring the new QoS, the operation at a new sTTI is required, but related procedures of the control plane functionality, which include synchronization acquisition and random access procedures of the terminal may be performed based on the legacy TTI or the new sTTI.

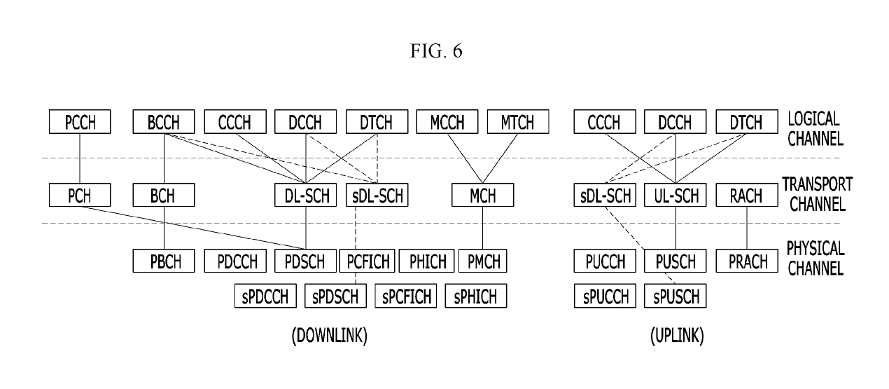

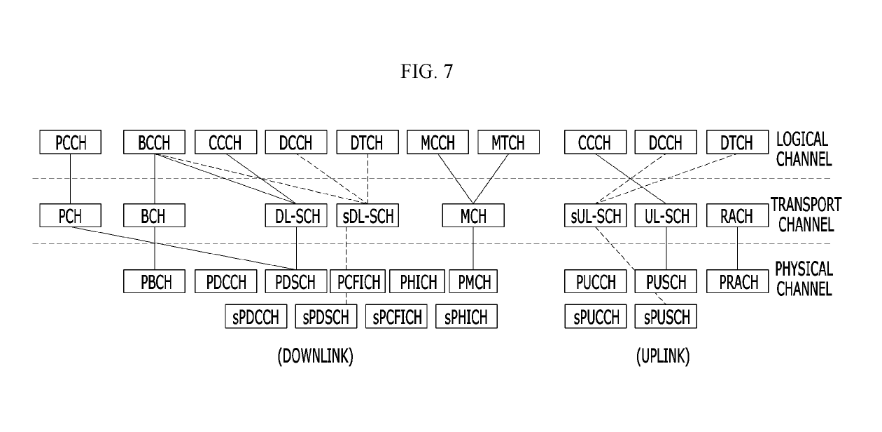

FIG. 6 is a diagram illustrating one example of a channel mapping relationship of a base station for supporting various TTIs according to an exemplary embodiment of the present invention and FIG. 7 is a diagram illustrating one example of a channel mapping relationship of a terminal for supporting various TTIs according to an exemplary embodiment of the present invention. Each of FIGS. 6 and 7 illustrates the channel mapping relationship of the base station and the terminal when only the user plane functionality supports the operation of the sTTI.

Referring to FIGS. 6 and 7, in the case of the legacy LTE/LTE-A system, which operates based on the legacy TTI having the length of 1 ms, the DL-SCH and the UL-SCH correspond to the transport channels associated with the functionality of the user plane and the BCH, the PCH, the RACH, and the like correspond to the transport channels associated with the functionality of the control plane. Transport channels which are newly added in association with the functionality of the user plane in order to support the operation of the sTTI are an sDL-SCH and an sUL-SCH and newly added physical channels are the sPDCCH, the sPDSCH, the sPCFICH, the sPHICH, the sPUCCH, and the sPUSCH. In order to distinguish the transport channels (the sDL-SCH and the sUL-SCH) and the physical channels (the sPDCCH, the sPDSCH, the sPCFICH, the sPHICH, the sPUCCH, and the sPUSCH) which are newly added in order to support the operation of the sTTI from the transport channels (the DL-SCH and the UL-SCH) and the physical channels (the PDCCH, the PDSCH, the PCFICH, the PHICH, the PUCCH, and the PUSCH) which operate based on the TTI having the length of 1 ms, “s” is just attached to the front of the channel and the function thereof is the same as the function of the corresponding channel.

The base station supports the terminal which operates at the TTI by using the legacy transport channels (the PCH, the BCH, the DL-SCH, the MCH, the UL-SCH, and the RACH) and the legacy physical channels (the PBCH, the PDCCH, the PDSCH, the PCFICH, the PHICH, the PUCCH, the PUSCH, and the PRACH) and supports the terminal which operates at the sTTI by using the newly added transport channels (the sDL-SCH and the sUL-SCH) and the newly added physical channels (the sPDCCH, the sPDSCH, the sPCFICH, the sPHICH, the sPUCCH, and the sPUSCH) to support all of terminals which operate at different TTIs. In this case, the configuration for each terminal may vary depending on a capability of the terminal.

In the case of the low-latency service requiring the new QoS, the downlink BCCH, CCCH, and DTCH are mapped to the sDL-SCH and the sDL-SCH is mapped to the sPDSCH. In addition, the uplink DCCH and DTCH are mapped to the sUL-SCH and the sUL-SCH is mapped to the sPUSCH.

That is, in the case of the base station for supporting the sTTI, in the downlink and the uplink, the new transport channels (the sDL-SCH and the sUL-SCH) and the new physical channels (the sPDCCH, the sPDSCH, the sPCFICH, the sPHICH, the sPUCCH, and the sPUSCH) may be configured and the logical channels, the transport channels, and the physical channels may be configured and mapped as illustrated in FIG. 6 and in the case of the terminal which operates based on the sTTI, in the downlink and the uplink, the new transport channels (the sDL-SCH and the sDL-SCH) and the new physical channels (the sPDCCH, the sPDSCH, the sPCFICH, the sPHICH, the sPUCCH, and the sPUSCH) may be configured and the logical channels, the transport channels, and the physical channels may be mapped as illustrated in FIG. 7.

On the contrary, the terminal which operates based on the legacy TTI may be constituted only by the legacy logical channels, transport channels, and physical channels. In all subsequent descriptions and drawings, the logical channel (MCCCH), the transport channel (MCH), and the physical channel (PMCH) for a multicast service do not be considered to change for the operation of the sTTI.

After the terminal accesses the base station, the RRC connection is configured and after the state of the terminal is changed to the RRC connected state, the new transport channels and the new physical channels which operate at the sTTI are configured while configuring a new dedicated RB (DRB) requiring a low latency and transmission/reception is performed through the newly configured transport channels and physical channels. addition, when the terminal is in the RRC idle state or in the case of the operation associated with the control plane functionality, such as the access procedure to the base station, and the like, the transmission/reception is performed by reusing the physical channels which operate at the legacy TTI before the DRB requiring the new sTTI operation to the corresponding terminal is configured.

Meanwhile, when the terminal which may operate at the sTTI continuously operates based on the sTTI regardless of the RRC state of the terminal, the corresponding terminal uses the new transport channels and the new physical channels that support the operation of the sTTI.

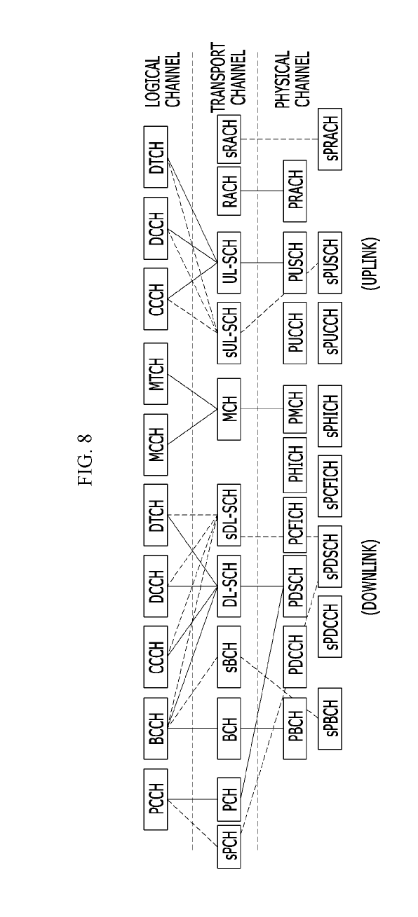

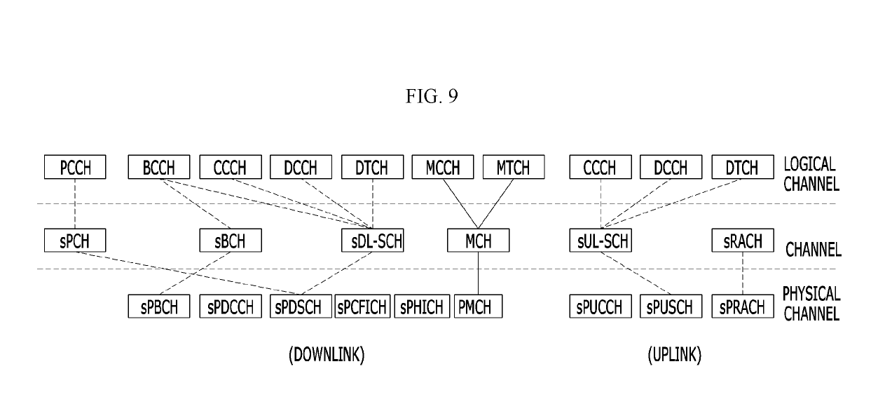

FIG. 8 is a diagram illustrating another example of a channel mapping relationship of a base station for supporting various TTIs according to an exemplary embodiment of the present invention, and FIG. 9 is a diagram illustrating another example of a channel mapping relationship of a terminal for supporting various TTIs according to an exemplary embodiment of the present invention. Each of FIGS. 8 and 9 illustrates the channel mapping relationship of the base station and the terminal in the case of supporting the operation of the sTTI in both the control plane functionality and the user plane functionality.

Referring to FIG. 8, the transport channels which are newly added in association with the functionality of the user plane in order to support the operation of the sTTI are the sDL-SCH and the sUL-SCH and the newly added physical channels are the sPDCCH, the sPDSCH, the sPCFICH, the sPHICH, the sPUCCH, and the sPUSCH. Further, the transport channels which are newly added in association with the functionality of the control plane in order to support the operation of the sTTI are the sPCH, the sBCH, and the sRACH and the newly added physical channels are the sPBCH and the sPRACH.

The logical channels (e.g., the PCCH, the BCCH, and the CCCH) associated with the function of the control plane is simultaneously mapped to the legacy transport channels (the PCH, the BCH, and the DL-SCH) and the new transport channels (the sPCH, the sBCH, and the sDL-SCH), the legacy transport channels (the PCH, the BCH, and the DL-SCH) are mapped to the legacy physical channels (the PDSCH, the PBCH, and the PDSCH), respectively, and the new transport channels (the sPCH, the sBCH, and the sDL-SCH) are mapped to the new physical channels (the sPDSCH, the sPBCH, and the sPDSCH), respectively.

The base station may provide both the transport channels (the PCH, the BCH, the DL-SCH, the MCH, the UL-SCH, and the RACH) and the physical channels (the PBCH, the PDCCH, the PDSCH, the PCFICH, the PHICH, the PUCCH, and the PUSCH) which operate at the legacy TTI and the new transport channels (the sDL-SCH,the sUL-SCH, the sPCH, the sBCH, and the sRACH) and the new physical channels (the sPDCCH, the sPDSCH, the sPCFICH, the sPHICH, the sPUCCH, the sPUSCH, the sPBCH, and sPRACH) which operate at the sTTI. In this case, the base station may support the operation of the terminal which operates at the legacy TTI by using the legacy transport channels (the PCH, the BCH, the DL-SCH, the MCH, the UL-SCH, and the RACH) and the legacy physical channels (the PBCH, the PDCCH, the PDSCH, the PCFICH, the PHICH, the PUCCH, and the PUSCH) and the operation of the terminal which supports the sTTI by using the new transport channels (the sDL-SCH, the sUL-SCH, the sPCH, the sBCH, and the sRACH) and the new physical channels (the sPDCCH, the sPDSCH, the sPCFICH, the sPHICH, the sPUCCH, the sPUSCH, the sPBCH, and sPRACH).

In the case of the terminal supporting the sTTI, the new transport channels (the sDL-SCH, the sUL-SCH, the sPCH, the sBCH, and the sRACH) and the new physical channels (the sPDCCH, the sPDSCH, the sPCFICH, the sPHICH, the sPUCCH, the sPUSCH, the sPBCH, and the sPRACH) may be configured and mapped as illustrated in FIG. 9.

The terminal supporting the operation of the sTTI may use the sRACH which is the new transport channel and the sPRACH which is the new physical channel for the synchronization acquisition and the access procedure of the base station.

As necessary, the base station may transmit signaling having the same contents through two transport channels and two physical channels within radio resource regions which are distinguished from each other at the same time and the terminals which operate in the respective radio resource regions may receive the corresponding contents in the regions thereof.

The structures of the MAC layer and the PHY layers supporting the new transport channels and the new physical channels may be configured in the resource regions which are distinguished from each other differently according to whether to support the CA and the DC.

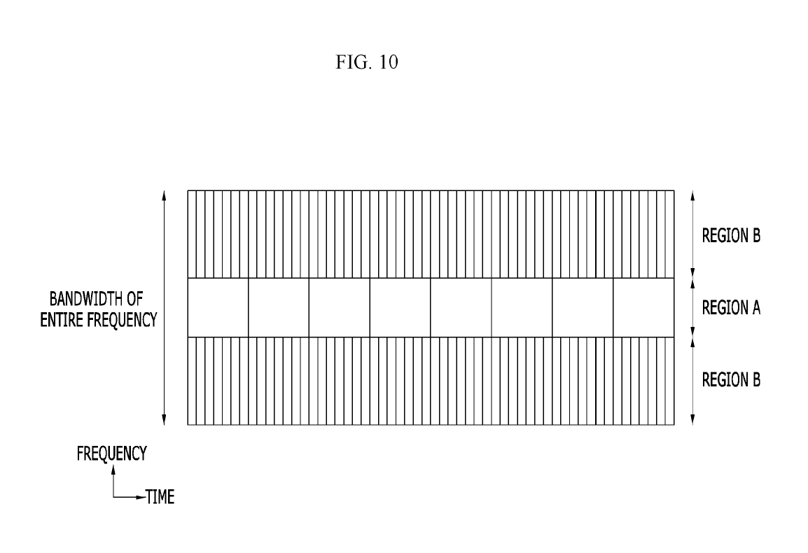

FIG. 10 is a diagram illustrating one example of a radio resource configuration for supporting various TTIs in a component carrier according to an exemplary embodiment of the present invention.

Referring to FIG. 10, an entire frequency band of one frame may be divided into region A for the operation of the TTI of the legacy value and region B for the operation of the sTTI within the single component carrier. For example, a frequency band in an intermediate part in the entire frequency band of one frame may be allocated to region A for the operation of the TTI of the legacy value and other frequency band may be allocated to region B for the operation of the sTTI.

As described above, the radio resource of one frame may be separated from a frequency domain in order to support the operations of the TTI of the legacy value and the new sTTI in one component carrier. Unlike this, the radio resource of one frame may be divided in order to support the operations of the TTI of the legacy value and the new sTTI in a time domain.

The operation of the terminal which operates based on the TTI of the legacy value is achieved through the legacy physical channels within region A for the operation of the TTI of the legacy value and the operation of the terminal which operates based on the sTTI is achieved through the new physical channels in region B for the operation of the sTTI.

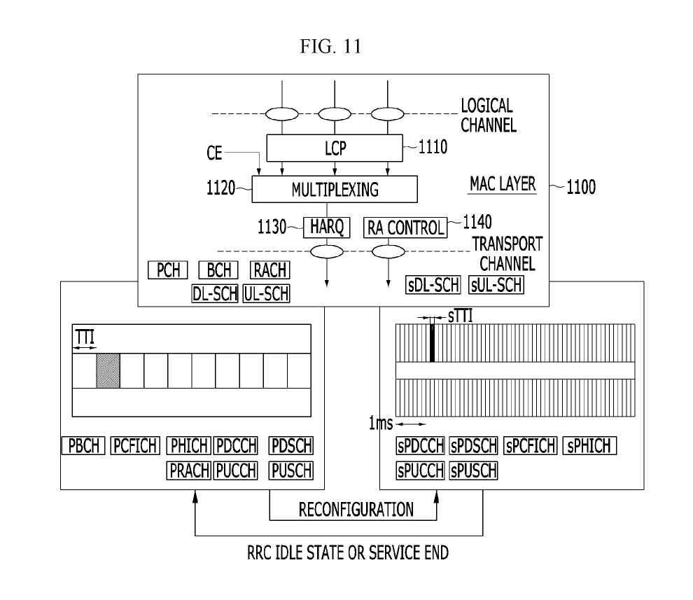

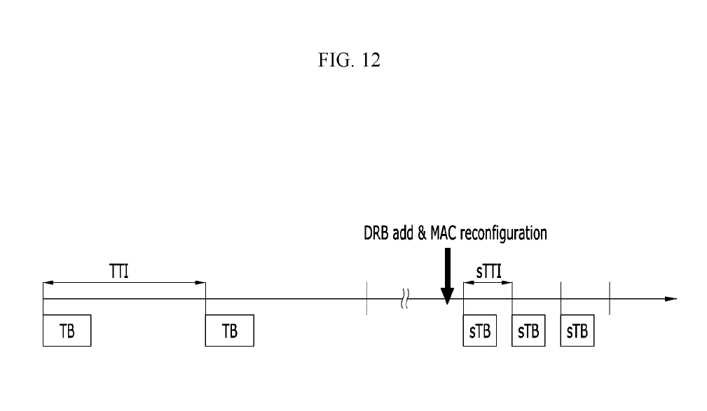

FIG. 11 is a diagram illustrating a detailed structure of the MAC layer and a reconfiguration process of the MAC layer of a terminal according to an exemplary embodiment of the present invention and FIG. 12 is a diagram for describing reconfiguration of the MAC layer of a terminal according to an exemplary embodiment of the present invention.

Referring to FIG. 11, the MAC layer 1100 of the terminal includes a logical channel prioritization (LCP) entity 1110, a multiplexing entity 1120, and an HARQ entity 1130. The MAC layer 1100 may further include a random access (RA) control entity 1140.

The LCP entity 1110 manages scheduling of data, the terminal, and the priorities of the logical channels.

The multiplexing entity 1120 multiplexes data of a plurality of logical channels to generate one TB and transfer the TB to the HARQ entity 1130.

The HARQ entity 1130 processes the TB to be transmitted on the transport channel and performs the HARQ. In general, the data of the plurality of logical channels are multiplexed to be transmitted to one transport channel.

As illustrated in FIG. 11, in a case of a system that supports only one component carrier, one HARQ entity 1130 is configured in the multiplexing entity 1120 and in the case of a system that supports multiple carriers, a plurality of HARQ entities may be configured in one multiplexing entity 1120.

The RA control entity 1140 processes the random access.

When only one component carrier is supported, the radio resource of one frame may be separated into region A for the operation at the TTI of the legacy value and region B for the operation of the sTTI as illustrated in FIG. 10. The legacy physical channels (the PBCH, the PDCCH, the PDSCH, the PCFICH, the PHICH, the PUCCH, the PUSCH, and the PRACH), which operate based on the TTI of the legacy value use the radio resource of region A for the operation of the TTI of the legacy value. When only the user plane functionality supports the operation of the sTTI, the physical channels (the sPDCCH, the sPDSCH, the sPCFICH, the sPHICH, the sPUCCH, and the sPUSCH) newly added in order to support the operation of the sTTI use the radio resource of region B for the operation of the sTTI. The legacy transport channels (the PCH, the BCH, the DL-SCH, the MCH, the UL-SCH, and the RACH) are mapped to the legacy physical channels (the PBCH, the PDCCH, the PDSCH, the PCFICH, the PHICH, the PUCCH, the PUSCH, and the PRACH) and the transport channels (the sDL-SCH and the sUL-SCH) newly added in order to support the operation of the sTTI are mapped to the newly added physical channels (the sPDCCH, the sPDSCH, the sPCFICH, the sPHICH, the sPUCCH, and the sPUSCH).

In this case, when the operation of the sTTI is supported only in the user plane functionality in order to support the new QoS, the transport channels newly added in association with the functionality of the user plane are the sDL-SCH and the sUL-SCH and the access procedure from the terminal to the base station is performed through the legacy transport channel (RACH) and the legacy physical channel (PRACH), which operate at the TTI of the legacy value by the RA control entity 1140.

As illustrated in FIG. 12, after the access procedure is completed, when the DRB of the service to require the operation of the sTTI is additionally configured while the services are provided at the TTI of the legacy value, the MAC layer may be reconfigured. That is, the base station configures and maps the legacy transport channel and the legacy physical channel associated with the SRB and DRB and newly reconfigures multiplexing operations to operate at the new sTTI. The legacy services may be transmitted/received through the new transport channels (the sDL-SCH and the sUL-SCH) and the new physical channels (the sPDCCH, the sPDSCH, the sPCFICH, the sPHICH, the sPUCCH, and the sPUSCH) which operate at the sTTI by using the reconfiguration procedure.

As described above, when the operation of the sTTI is supported only in the user plane functionality, the transport channels (the PCH, the BCH, and the RACH) associated with the functionality of the control plane are not newly configured. However, as described in FIG. 7, mapping may be changed from the logical channel (BCCH) provided through the legacy DL-SCH to the new transport channel (sDL-SCH). When the service to require the operation of the sTTI ends or the state of the terminal is changed to the RRC idle state, and the like, the terminal operates at the TTI again and may be reconfigured to resume the transmitting/receiving operation through the legacy transport channels (the PCH, the BCH, the DL-SCH, the MCH, the UL-SCH, and the RACH) and the legacy physical channels (the PBCH, the PDCCH, the PDSCH, the PCFICH, the PHICH, the PUCCH, the PUSCH, and the PRACH).

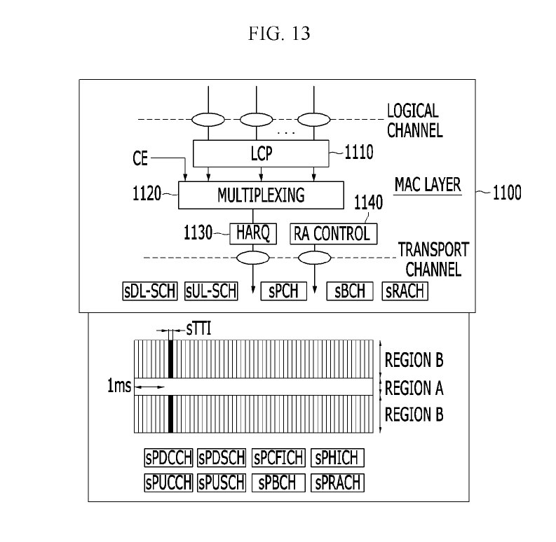

FIG. 13 is a diagram illustrating another example of a detailed structure of the MAC layer of a terminal according to an exemplary embodiment of the present invention.

Referring to FIG. 13, when the operation of the sTTI is supported in the control plane functionality as well as the user plane functionality, all transport channels (the sDL-SCH, the sUL-SCH, the sPCH, the sBCH, and the sRACH) and physical channels (the sPDCCH, the sPDSCH, the sPCFICH, the sPHICH, the sPUCCH, the sPUSCH, the sPBCH, and the sPRACH) which are distinguished from the related art are newly configured in order to support the operation of the sTTI. The new physical channels (the sPDCCH, the sPDSCH, the sPCFICH, the sPHICH, the sPUCCH, the sPUSCH, the sPBCH, and the sPRACH) which operate at the sTTI are allocated into the sTTI region and the new transport channels (the sDL-SCH, the sUL-SCH, the sPCH, the sBCH, and the sRACH) which operate at the sTTI are mapped to the new physical channels (the sPDCCH, the sPDSCH, the sPCFICH, the sPHICH, the sPUCCH, the sPUSCH, the sPBCH, and the sPRACH). The terminal may perform the transmitting/receiving operation through the new transport channels (the sDL-SCH, the sUL-SCH, the sPCH, the sBCH, and the sRACH) and the new physical channels (the sPDCCH, the sPDSCH, the sPCFICH, the sPHICH, the sPUCCH, the sPUSCH, the sPBCH, and the sPRACH).

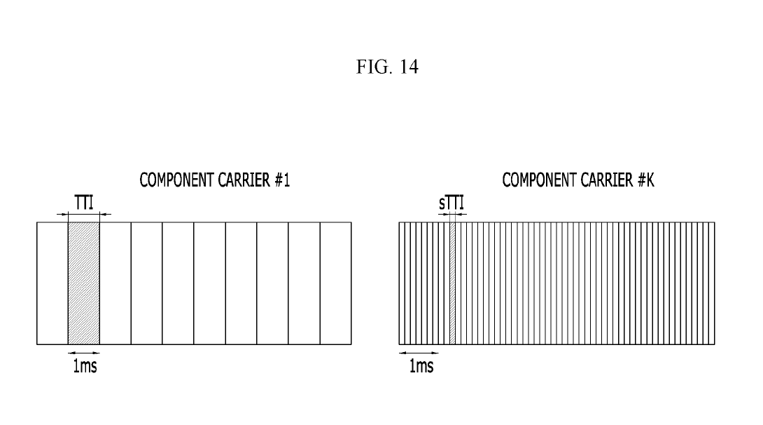

FIG. 14 is a diagram illustrating one example of a radio resource configuration for supporting various TTIs when multiple component carriers are supported according to an exemplary embodiment of the present invention.

Referring to FIG. 14, when multiple component carriers are supported, since an independent PHY layer is configured for each component carrier, different TTIs may be applied for each component carrier.

For example, a frame structure which operates at the TTI of the legacy value may be supported in component carrier #1 and the legacy physical channels (the PBCH, the PDCCH, the PDSCH, the PCFICH, the PHICH, the PUCCH, and the PUSCH) and the legacy transport channels (the PCH, the BCH, the DL-SCH, the MCH, the UL-SCH, and the RACH) may be configured. The frame structure which operates at the sTTI may be supported in component carrier #k and the new physical channels (the sPDCCH, the sPDSCH, the sPCFICH, the sPHICH, the sPUCCH, the sPUSCH, the sPBCH, and the sPRACH) and the new transport channels (the sDL-SCH, the sUL-SCH, the sPCH, the sBCH, and the sRACH) may be configured.

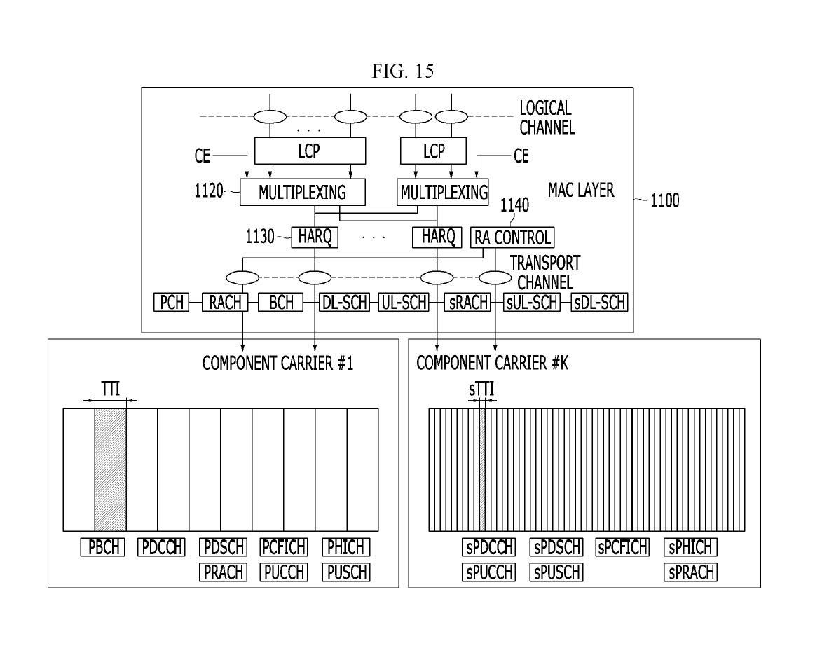

FIG. 15 is a diagram illustrating one example of a detailed structure of the MAC layer of a terminal when multiple component carriers are supported according to an exemplary embodiment of the present invention.

Referring to FIG. 15, when multiple component carriers are supported, the HARQ entity 1130 is configured to correspond to each component carrier. Each HARQ entity 1130 independently processes the TB or sTB. In this case, one MAC layer 1100 may manage the PHY layer of each component carrier and the MAC layer 1100 may configure different TTI values for each component carrier. For example, in component carrier #1, the TTI of the legacy value may be configured and in component carrier #k, the sTTI may be configured.

In order to support the operations of different TTIs for each component carrier, the MAC layer 1100, the transport channels (the PCH, the BCH, the DL-SCH, the MCH, the UL-SCH, and the RACH) and the physical channels (the PBCH, the PDCCH, the PDSCH, the PCFICH, the PHICH, the PUCCH, the PUSCH, and the PRACH) which operate at the TTI of the legacy value and the new transport channels (the and the new physical channels (the sPDCCH, the sPDSCH, the sPCFICH, the sPHICH, the sPUCCH, the sPUSCH, the sPBCH, and the Sprach) which operate at the sTTI may be simultaneously present. Further, in the MAC layer 1100, the TB and the sTB which are distinguished from each other may be configured through multiplexing according to features of the logical channels associated with the legacy service and the low-latency service. The TB may be transmitted/received through the transport channels (the PCH, the BCH, the DL-SCH, the MCH, the UL-SCH, and the RACH) and the physical channels (the PBCH, the PDCCH, the PDSCH, the PCFICH, the PHICH, the PUCCH, and the PUSCH) which are configured to operate at the TTI of the legacy value and the sTB may be transmitted/received through the new transport channels (the sDL-SCH, the sUL-SCH, the sPCH, the sBCH, and the sRACH) and the new physical channels (the sPDCCH, the sPDSCH, the sPCFICH, the sPHICH, the sPUCCH, the sPUSCH, the sPBCH, and the sPRACH) which are configured to operate at the sTTI.

Further, when the logical channel is configured to be dually mapped to the transport channels which operate at the TTI of the legacy value and the sTTI, each of the configured TB and sTB may be transmitted/received through the transport channels and the physical channels of the component carrier configured to operate at different TTIs according to determination of a scheduler.

The multiple carriers used for the carrier aggregation may be classified into a primary component carrier (PCC) and a secondary component carrier (SCC). The PCC may be referred to as a primary cell (P-cell) and the SCC may be referred to as a secondary cell (S-cell). In the case where the P cell is the component carrier that supports the operation of the TTI of the legacy value, when a P cell concept of the legacy CA operation is applied, the operation associated with the control plane functionality of the terminal is achieved only through the component carrier corresponding to the P cell as illustrated in FIG. 15. Accordingly, the new transport channel and the new physical channel associated with the control plane functionality are not configured in the component carrier corresponding to the S cell like the case where the sTTI is applied only in the user plane functionality. However, in this case, the transport channel (sRACH) and the physical channel (sPRACH) for supporting the random access by a PDCCH order of the base station may be configured even in the S cell. When the terminal configures the P cell as the component carrier which operates at the sTTI, the operation of the sTTI may be supported even in the control plane functionality of the terminal and the new transport channels (the sDL-SCH, the sUL-the SCH, the sPCH, the sBCH, and the sRACH) and the new physical channels (the sPDCCH, the sPDSCH, the sPCFICH, the sPHICH, the sPUCCH, the sPUSCH, the sPBCH, and the sPRACH) which support the operation of the sTTI are all configured in the corresponding component carrier.

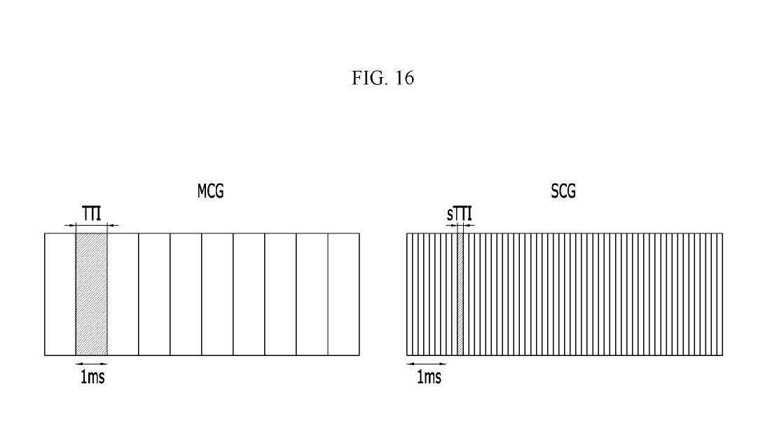

FIG. 16 is a diagram illustrating one example of a radio resource configuration for supporting various TTIs when dual connectivity is supported according to an exemplary embodiment of the present invention.

Referring to FIG. 16, the DC may be an operation in which the terminal which is configured in the RRC connected state with two or more base stations consumes the radio resources provided by two or more base stations. One of two or more base stations is a master base station and the remaining base stations are secondary base stations.

When it is assumed that the terminal supporting the CA communicates with multiple base stations based on the dual connectivity, multiple aggregated serving cells may be provided by different base stations. Among the serving cells configured in the terminal, a serving cell group (master cell group) provided by the master base station is referred to as MCG and a serving cell group provided by the secondary base station is referred to as SCG. For example, it is assumed that a primary serving cell, a first secondary serving cell, and a second secondary serving cell are configured in the terminal by the CA. In case of the dual connectivity, the primary serving cell and the first secondary serving cell may be included in the MCG provided by the master base station and the second secondary serving cell may be included in the SCG provided by the secondary base station. In this case, the MCG and the SCG may be configured to operate based on different TTI values. For example, the MCG may be configured to operate based on the TTI of the legacy value of 1 ms and the SCG may be configured to operate based on the sTTI.

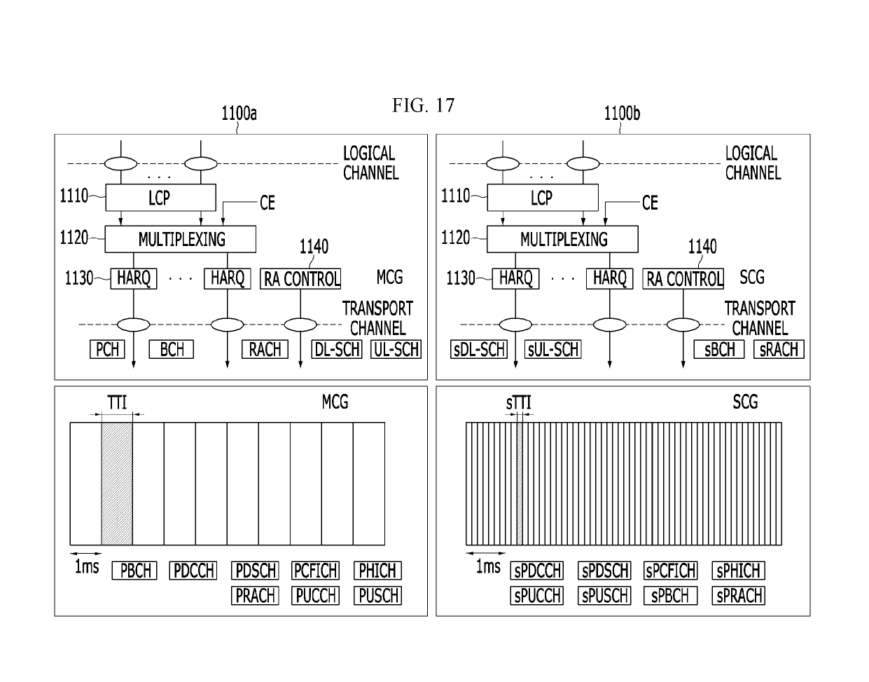

FIG. 17 is a diagram illustrating one example of a detailed structure of the MAC layer of a terminal when dual connectivity is supported according to an exemplary embodiment of the present invention.

Referring to FIG. 17, when the DC is supported, the MAC layer of the terminal configures each of the transport channels and the physical channels depending on the TTI supported by each of the multiple connected base stations.

In the case of the DC, the MAC entities for connection with the master base station and the second base station are distinguished, but the RRC entity is present only for connection with the master base station. Therefore, the SRBs are configured only in the MCG of the terminal. That is, the logical channels (the PCCH, the CCCH, and the DCCH) associated with the control plane functionality are configured only in the MAC layer and the BCCH and the DTCH are configured in both the MAC layers of the master base station and the second base station. Therefore, when the DC is supported, the transport channel and the physical channel associated with the functionality of the control plane are configured only in the MAC layer of the master base station.

When the terminal is supported with the service of the new QoS through the secondary base station, the transport channels (the PCH, the BCH, the DL-SCH, the MCH, the UL-SCH, and the RACH) and the physical channels (the PBCH, the PDCCH, the PDSCH, the PCFICH, the PHICH, the PUCCH, and the PUSCH) which operate at the TTI of the legacy value are configured in the MAC layer 1100a of the MCG of the terminal which communicates with the master base station and the new transport channels (the sDL-SCH, the sUL-SCH, the sPCH, the sBCH, and the sRACH) and the new physical channels (the sPDCCH, the sPDSCH, the sPCFICH, the sPHICH, the sPUCCH, the sPUSCH, the sPBCH, and the sPRACH) which operate at the sTTI are configured in a MAC layer 1100b of the SCG of the terminal which communicates with the secondary base station. In this case, as illustrated in FIG. 17, the PCH is configured only in the MAC layer 1100a of the MCG. Further, since the CCCH and the DCCH of the terminal are provided only through the DL-SCH and the UL-SCH of the MCG, the functionality of the control plane is excluded and the sTTI is applied to some RBs during the operation of the user plane functionality in the MAC layer 1100b. In this case, the procedures including the reconfiguration of the MAC layer, and the like are not required unlike the case of one component carrier.

Meanwhile, when the terminal is supported with the service of the new QoS through the master base station, the functionality of the control plane may also support the operation of the sTTI and the new transport channels (the sDL-SCH, the sUL-the SCH, the sPCH, the sBCH, and the sRACH) and the new physical channels (the sPDCCH, the sPDSCH, the sPCFICH, the sPHICH, the sPUCCH, the sPUSCH, the sPBCH, and the sPRACH) which operate at the sTTI may be all configured even in the MAC layer 1100a of the MCG, which takes charge of transmission/reception with the corresponding master base statio.

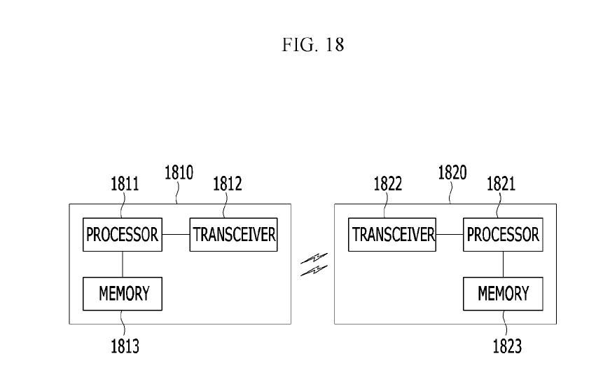

FIG. 18 is a diagram illustrating an apparatus for supporting various TTIs according to an exemplary embodiment of the present invention.

Referring to FIG. 18, the apparatus 1810 for supporting various transmission time intervals of the terminal includes a processor 1811, a transceiver 1812, and a memory 1813. The processor 1811 implements the function of the terminal, the process, and/or the method which are described above. The functions of the MAC layer and the PHY layer may be implemented by the processor 1811. The transceiver 1812 is connected with the processor 1811 to transmit and/or receive a radio signal. The memory 1813 is connected with the processor 1811 to store various pieces of information for driving the processor 1811.

The apparatus 1820 for supporting various transmission time intervals of the base station includes a processor 1821, a transceiver 1822, and a memory 1823. The processor 1821 implements the function of the base station, the process, and/or the method which are described above. The functions of the MAC layer and the PHY layer of the base station may be implemented by the processor 1821. The transceiver 1822 is connected with the processor 1821 to transmit and/or receive the radio signal. The memory 1823 is connected with the processor 1821 to store various pieces of information for driving the processor 1821.

The processors 1811 and 1821 may include an application-specific integrated circuit (ASIC), another chip set, a logic circuit and/or a data processing apparatus. The transceivers 1812 and 1822 may include a baseband circuit for processing the radio signal. The memories 1813 and 1823 may include a read-only memory (ROM), a random access memory (RAM), a flash memory, a memory card, a storage medium, and/or other storage devices. The memories 1813 and 1823 store commands to be executed by the processors 1811 and 1821 or load the commands from a storage device (not illustrated) and temporarily store the loaded commands. The processors 1811 and 1812 may execute the commands which are stored in or loaded to the memories 1813 and 1823.

According to exemplary embodiments of the present invention, a terminal can operate so as to provide a low-latency service requiring a new QoS while providing the legacy service without changing the legacy signaling procedure, and the like. Accordingly, various services requiring a short transmission delay of a radio section can be provided.

The exemplary embodiments of the present invention are not embodied only by the apparatus and/or the method described above and the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for supporting various transmission time intervals (TTIs) having different values by a terminal, the method comprising:
transmitting data by using legacy transport channels and legacy physical channels, which operate based on a first TTI;
configuring, new transport channels and new physical channels which operate based on the second TTI while configuring a new radio bearer when a service requiring an operation of a new second TTI is generated; and
transmitting data of the service by using the new transport channels and the new physical channels.

2. The method of claim 1, wherein:
a first radio resource in which the new physical channels are transmitted is different from a second radio resource in which the legacy physical channels are transmitted.

3. The method of claim 2, wherein:
the first radio resource is a radio resource in a first region in a radio frame of a component carrier and the second radio resource is the radio resource in a second region different from the first region in the radio frame of the single component carrier.

4. The method of claim 1, wherein:
the configuring of the new transport channels and the new physical channels includes configuring the new transport channels and the new physical channels by using the radio frame of a first component carrier among multiple component carriers when the terminal supports carrier aggregation, and
the legacy transport channels and the legacy physical channels are configured by using the radio frame of a second component carrier different from the first component carrier among the multiple component carriers.

5. The method of claim 1, wherein:
the configuring of the new transport channels and the new physical channels includes configuring the new transport channels and the new physical channels in one group of a master cell group and a secondary cell group when the terminal supports the carrier aggregation and dual connectivity, and
the legacy transport channels and the legacy physical channels are configured in the other cell group of the master cell group and the second cell group.

6. The method of claim 1, wherein:
the configuring of the new transport channels and the new physical channels includes
configuring, when the operation of the second TTI is supported only in a user plane functionality, new transport channels and new physical channels associated with the functionality of the user plane, and
configuring, when the operation of the second TTI is supported in both the control plane and the user plane, new transport channels and new physical channels associated with the functionality of the control plane and the user plane.

7. The method of claim 1, further comprising:
performing a transmitting/receiving operation by using the legacy transport channels and the legacy physical channels when the service ends.

8. The method of claim 1, further comprising:
performing the transmitting/receiving operation by using the legacy transport channels and the legacy physical channels when a state of the terminal becomes a radio resource control idle (RRC IDLE) state.

9. An apparatus for supporting various transmission time intervals (TTIs) having different values by a terminal, the apparatus comprising:
a processor configuring, when a new service requiring an operation of a new second TTI is generated while services are provided by using legacy transport channels and legacy physical channels which operate at a first TTI, new transport channels and new physical channels which operate at the second TTI; and
a transceiver transmitting and receiving data of the new service by using a radio resource of the new physical channels.

10. The apparatus of claim 9, wherein:
the first TTI has a time length of 1 ms and the second TTI has a shorter time length than the first TTI.

11. The apparatus of claim 9, wherein:
the processor configures new transport channels and new physical channels which operate based on the second TTI in the medium access control (MAC) layer and the physical layer while configuring a new radio bearer for the new service.

12. The apparatus of claim 11, wherein:
the processor configures the new physical channels by using the radio resource different from the radio resource of the legacy physical channels.

13. The apparatus of claim 12, wherein:
the processor configures the new physical channels by using the radio frame of a first component carrier among multiple component carriers and configures the legacy physical channels by using the radio frame of a second component carrier different from the first component carrier, when the terminal supports carrier aggregation.

14. The apparatus of claim 12, wherein:
the processor configures the new physical channels by using the radio resource in a partial region of the radio frame of a component carrier and configures the legacy physical channels by using the radio resource in the remaining partial region of the radio frame of the single component carrier.

15. The apparatus of claim 12, wherein:
the processor configures the new transport channels and the new physical channels in one group of a master cell group and a secondary cell group when the terminal supports the carrier aggregation and dual connectivity and configures the legacy transport channels and the legacy physical channels in the other cell group.

16. An apparatus for supporting various transmission time intervals (TTIs) having different values by a base station, the apparatus comprising:
a processor distinguishing transport channels and physical channels for each of TTIs having different time lengths from each other and configuring the transport channels and physical channels; and
a transceiver transmitting and receiving data of a service by using transport channels and physical channels which operate based on a TTI required by the service.

17. The apparatus of claim 16, wherein:
the processor separately configures the physical layer for each TTI.

18. The apparatus of claim 17, wherein:
the processor distinguishes a radio resource region for each TTI in a radio frame of a component carrier and configures the physical channels for each TTI by using the radio resource region distinguished for each TTI.

19. The apparatus of claim 17, wherein:
the processor configures different TTIs for each component carrier when multiple component carriers are supported.

20. The apparatus of claim 17, wherein:
the processor configures the transport channels and physical channels associated with a functionality of a user plane for each TTI for secondary base station and configures transport channels and physical channels associated with the functionality of both the control plane and the user plane for each TTI for master base station when the terminal which communicates with the base stations supports dual connectivity.
